(19) United States
(12) Patent Application Publication
(10) Pub. No.: US 2026/0075248 A1
(43) Pub. Date: Mar. 12, 2026

(54) TRANSFORMING VIDEO DATA USING NON-SEPARABLE PRIMARY TRANSFORMS

(71) Applicant: QUALCOMM Incorporated, San Diego, CA (US)

(72) Inventors: Patrick Garus, München (DE); Muhammed Zeyd Coban, Carlsbad, CA (US); Bappaditya Ray, San Diego, CA (US); Vadim Seregin, San Diego, CA (US); Marta Karczewicz, San Diego, CA (US)

(21) Appl. No.: 19/394,427

(22) Filed: Nov. 19, 2025

Related U.S. Application Data
(63) Continuation of application No. 18/485,707, filed on Oct. 12, 2023.
(60) Provisional application No. 63/379,422, filed on Oct. 13, 2022.
(60) Provisional application No. 63/385,678, filed on Dec. 1, 2022.

(51) Int. Cl. H04N 19/61; H04N 19/11; H04N 19/122; H04N 19/124; H04N 19/176; H04N 19/593

(52) U.S. Cl. CPC H04N 19/61; H04N 19/11; H04N 19/122; H04N 19/176; H04N 19/593; H04N 19/124

(57) ABSTRACT

An example device for decoding video data includes a memory configured to store video data; and a processing system comprising one or more processors implemented in circuitry, the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

This application is a continuation of U.S. application Ser. No. 18/485,707, filed Oct. 12, 2023, which claims the benefit of U.S. Provisional Application No. 63/379,422, filed Oct. 13, 2022, and of U.S. Provisional Application No. 63/385,678, filed Dec. 1, 2022, the entire contents of each of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to transforming video data during video coding. That is, a transform is used to convert representations of residual video data (representing differences between an uncoded block and a prediction block) between a spatial or pixel domain and a frequency domain. For example, during video encoding, the residual block may be transformed to a transform block in the frequency domain, whereas during video decoding, the transform block may be transformed from the frequency domain to a reconstructed residual block in the spatial or pixel domain. This disclosure describes techniques related to using a non-separable primary transform when transforming or inverse transforming video data.

In one example, a method of decoding video data includes inverse transforming a block of transform coefficients of a block of video data using an inverse non-separable primary transform (NSPT), without using an inverse separable transform, to reconstruct a residual block of the block of video data; and decoding the block of video data using the residual block.

In another example, a device for decoding video data includes a memory configured to store video data; and a processing system comprising one or more processors implemented in circuitry, the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

In another example, a device for decoding video data includes means for inverse transforming a block of transform coefficients of a block of video data using an inverse non-separable primary transform (NSPT), without using an inverse separable transform, to reconstruct a residual block of the block of video data; and means for decoding the block of video data using the residual block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIGS. 4A and 4B are conceptual diagrams illustrating the use of separable and low-frequency non-separable transforms (LFNSTs) when encoding and decoding video data.

FIG. 5 is a conceptual diagram illustrating an inverse non-separable primary transform (NSPT) process.

FIGS. 6A-6C are conceptual diagrams illustrating example scan patterns for reorganizing inverse quantized coefficients prior to application of an NSPT.

FIG. 7 is a conceptual diagram illustrating a reordered one-dimensional array from a two-dimensional matrix.

FIG. 8 is a conceptual diagram illustrating de-interlacing of a set of decoded coefficients into four one-dimensional arrays.

FIG. 9 is a flowchart illustrating an example method for encoding a current block in accordance with the techniques of this disclosure.

FIG. 10 is a flowchart illustrating an example method for decoding a current block in accordance with the techniques of this disclosure.

FIG. 11 is a flowchart illustrating an example method of encoding video data using a non-separable primary transform (NSPT) according to techniques of this disclosure.

FIG. 12 is a flowchart illustrating an example method of decoding video data using a non-separable primary transform (NSPT) according to techniques of this disclosure.

### DETAILED DESCRIPTION

Video encoding generally includes forming a prediction block for a current block of video data, then calculating differences between the current block and the prediction block to form a residual block. The video encoder may then apply one or more transforms to the residual block to produce a transform block in a transform domain. A “transform block” may be a block of transform coefficients. A video decoder may perform an inverse process, in that the video decoder may decode the transform block, inverse transform the transform block to reproduce the residual block, then add the residual block to the prediction block to reproduce the original, uncoded block of video data.

In video coding standards prior to ITU-T H.265/High Efficiency Video Coding (HEVC), only a fixed separable transform was used, such as DCT-2 that may be used both vertically and horizontally. HEVC added DST-7 as a possible transform in addition to DCT-2 for 4×4 blocks as a fixed separable transform.

A low frequency non-separable transform (LFNST) may also be applied, in addition to a separable transform, to further improve coding efficiency. LFNSTs are non-separable secondary transforms (NSSTs) that are applied to primary transform coefficients resulting from the application of separable transforms as a primary transform.

In some examples, three LFNST classes (LFNST4, LFNST8, LFNST16) can be used depending on the shape of a block of video data. Each of these classes may include, e.g., 35 sets and 3 candidates. In one example, LFNST4 is applied on blocks of size 4×N/N×4 (N≥4), LFNST8 is applied on blocks of size 8×N/N×8 (N≥8), and LFNST16 is applied on blocks of size M×N (M, N≥16).

In some examples, a set is chosen based on the intra mode of the current block. Intra modes may be mapped to one of the 35 sets according to the following look up table:

const uint8_t g_nsptLut[97] =
{ // 0 1 2 3 4 5 6 7 8 9 10 11 12 13 14 15 16 17 18 19 20 21
22 23 24 25 26 27 28 29 30 31 32 33 34 35 36 37 38 39 40 41 42
43 44 45 46 47 48 49 50 51 52 53 54 55 56 57 58 59 60 61 62 63
64 65 66 67 68 69 70 71 72 73 74 75 76 77 78 79 80 81 82 83 84
85 86 87 88 89 90 91 92 93 94 95 96
+0, 1, 2, 3, 4, 5, 6, 7, 8, 9, 10, 11, 12, 13, 14, 15, 16, 17, 18, 19, 20, 21, 22, 23,
24, 25, 26, 27, 28, 29, 30, 31, 32, 33, 34, 33, 32, 31, 30, 29, 28, 27, 26, 25, 24,
23, 22, 21, 20, 19, 18, 17, 16, 15, 14, 13, 12, 11, 10, 9, 8, 7, 6, 5, 4, 3, 2, 2, 2, 2,
2, 2, 2, 2, 2, 2, 2, 2, 2, 2, 2, 2, 2, 2, 2, 2, 2, 2, 2, 2, 2, 2, 2, 2, 2, 2, 2
};

In some examples, for intra modes >34, the corresponding block of primary transform coefficients is transposed prior the application of LFNST.

The sign of transform coefficients can be predicted as part of a sign prediction process. In some examples, the prediction area is adaptively selected as a 32×32 region, and the number of predicted signs is configurable for non-LFNST transform blocks. In the case of LFNST, the prediction area may be limited to a top-left 4×4 area, and a maximum of 4 coefficients may be predicted.

This disclosure describes techniques that include using Non-Separable Primary Transforms (NSPTs) as an addition to existing transform kernels. NSPTs are an additional class of transforms applied directly on the residual data and, therefore, do not require a separable transform beforehand. Using NSPTs, as opposed to using both separable and LFNSTs, may improve coding efficiency that can be achieved using larger NSPT transform kernels (i.e., larger than separable transform kernels).

According to the techniques of this disclosure, affected block shapes may be processed using NSPTs. Each block shape can be processed by dedicated NSPT kernels, which can vary in numbers of sets and candidates. If a block shape indicates the processing through NSPT, separable primary transform plus LFNST is not applied. Consequently, the compression efficiency may be improved.

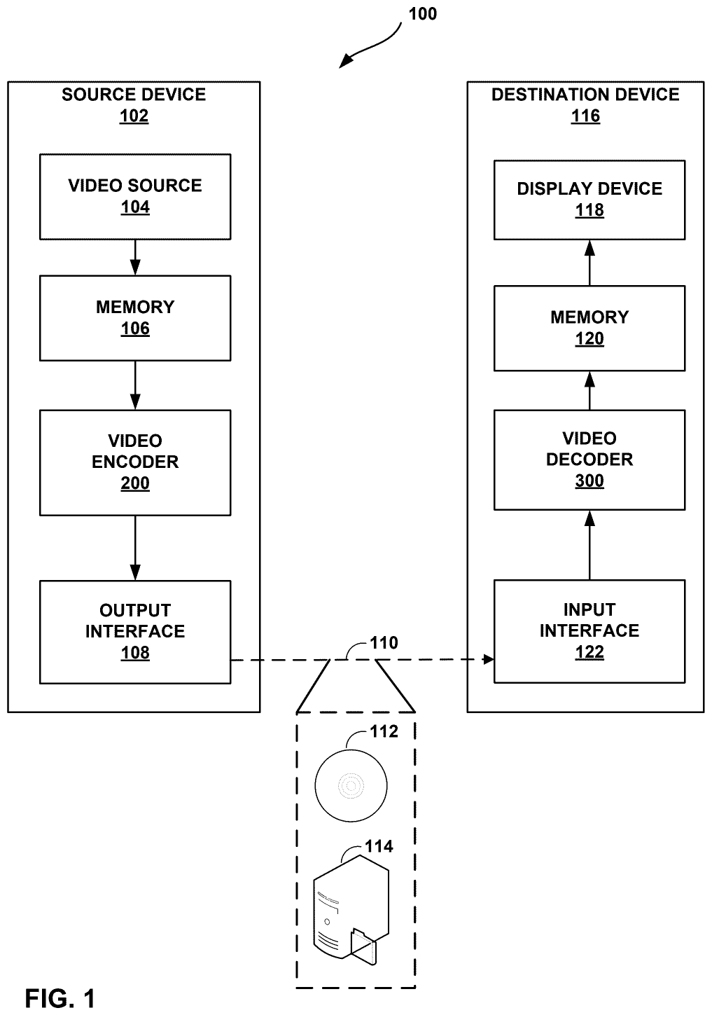

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for transforming video data using non-separable primary transforms. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for transforming video data using NSPTs. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that transform video data using NSPTs.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

In accordance with the techniques of this disclosure, video encoder 200 may determine to apply a non-separable primary transform (NSPT) to the residual block, without applying a separable transform to the residual block before applying the NSPT. Because the NSPT is applied without a separable transform, video encoder 200 may apply the NSPT to the entire residual block. Video encoder 200 may determine to apply the NSPT according to a prediction mode used to form a corresponding prediction block and/or according to the size of the residual block. For example, video encoder 200 may determine that the residual block has a size of one of 4×4, 4×8, 8×4, 4×16, 16×4, 8×8, 8×16, or 16×8. Video encoder 200 may include different NSPTs for different sizes of residual blocks and/or for different prediction modes (e.g., various intra prediction modes). Thus, the combination of the particular intra prediction mode and the size of the residual block may be mapped to a particular NSPT. For blocks having sizes other than those mapped to NSPTs, and/or other prediction modes (e.g., inter-prediction or affine), video encoder 200 may apply a conventional separable transform, which may be followed by application of a low-frequency non-separable transform, which video encoder 200 may apply to only a portion of the resulting transform block.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In accordance with the techniques of this disclosure, video decoder 300 may entropy decode a set of quantized transform coefficients for a current block, along with data indicating a size of the block and a prediction mode for the block. Video decoder 300 may inverse quantize the quantized transform coefficients and inverse scan the resulting transform candidates to reconstruct a transform block. If the size and/or prediction mode are mapped to a non-separable primary transform (NSPT), video decoder 300 may apply an inverse NSPT corresponding to the NSPT to which the size and/or prediction mode are mapped to the transform block to reconstruct a residual block for the block.

Alternatively, if the size and/or prediction mode, or other data indicative of the potential use of an NSPT, are not mapped to an NSPT, video decoder 300 may determine an inverse separable transform to apply to the transform block. In some examples, video decoder 300 may also determine a low-frequency non-separable transform (LFNST) to apply to the transform block. The transform block may also be referred to as a block of transform coefficients.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

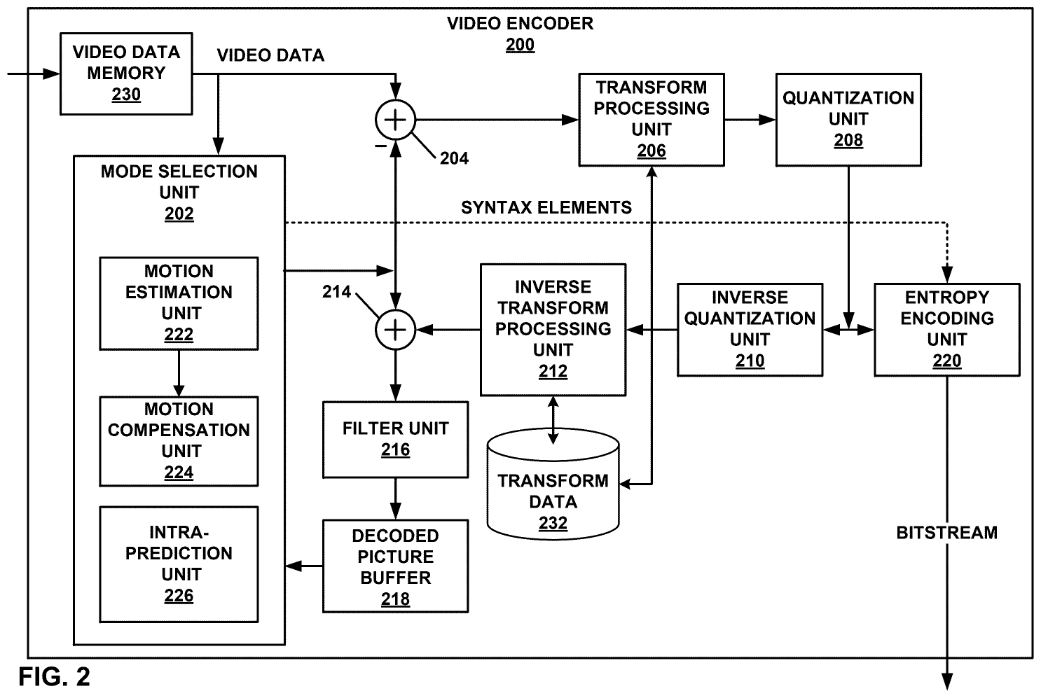

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266, under development) and HEVC (ITU-T H.265). However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, entropy encoding unit 220, and transform data 232. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

According to the techniques of this disclosure, transform processing unit 206 may determine a transform to apply to the residual block using transform data 232. Transform data 232 represents one or more computer-readable media devices, e.g., memory, storing data for various transforms, such as separable transforms, low-frequency non-separable transforms (LFNSTs), and non-separable primary transforms (NSPTs). The NSPTs may be non-separable transforms that are applied directly to the residual block, without an intervening separable transform. That is, transform processing unit 206 may apply the NSPT to the residual block without applying any separable transform to the block.

In addition, transform data 232 may store data mapping various characteristics of blocks to the various transforms. For example, transform data 232 may store data that maps a block size and/or prediction mode data to corresponding transforms. In the case of NSPTs, the data may map blocks having sizes of 4×4, 4×8, 8×4, 4×16, 16×4, 8×8, 8×16, or 16×8 to NSPTs. The data may also map blocks corresponding to prediction blocks formed using various intra-prediction modes to the NSPTs. Thus, in some examples, transform processing unit 206 may apply an NSPT to a residual block having a size of 4×4, 4×8, 8×4, 4×16, 16×4, 8×8, 8×16, or 16×8 and that was formed using a prediction block that was generated according to an intra-prediction mode. For other modes and block sizes, transform processing unit 206 may select a separable transform according to the mapping data, and in some examples, an LFNST to be applied following the separable transform.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block.

As noted above, in some examples, transform processing unit 206 may have applied a NSPT to a residual block to generate a transform block. In such cases, e.g., based on a size and prediction mode for a block corresponding to the transform block, inverse transform processing unit 212 may determine an inverse NSPT to be applied to the transform block to reconstruct the corresponding residual block. That is, inverse transform processing unit 212 may apply the inverse NSPT to directly reconstruct the residual block, without also applying a separable transform to reconstruct the residual block. In cases where transform processing unit 206 applied a separable transform (potentially followed by an LFNST) to the residual block, however, inverse transform processing unit 212 may retrieve a corresponding inverse LFNST (if applicable) and a corresponding inverse separable transform from transform data 232 and apply the inverse LFNST and inverse separable transform to the transform block to reconstruct the residual block.

Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

In this manner, video encoder 200 represents an example of a device for decoding video data including a memory configured to store video data; and a processing system comprising one or more processors implemented in circuitry (e.g., inverse transform processing unit 212 and reconstruction unit 214), the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

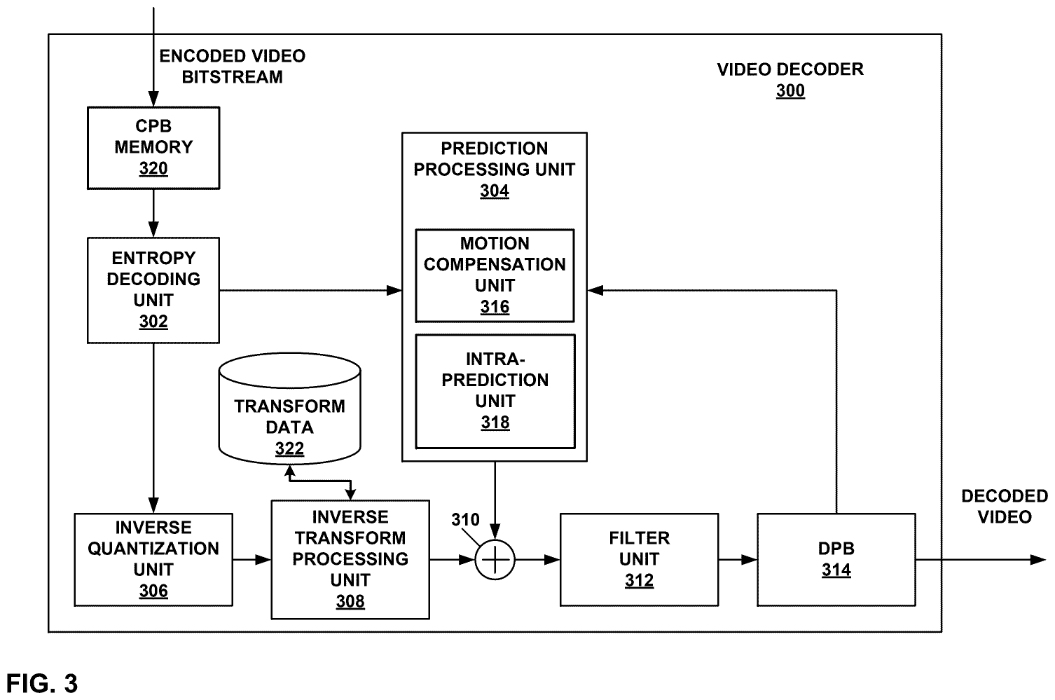

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266, under development) and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, transform data 322, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

In accordance with the techniques of this disclosure, transform data 322 includes coefficients for a variety of inverse transforms, e.g., inverse separable transforms, inverse low-frequency non-separable transforms (LFNSTs), and inverse non-separable primary transforms (NSPTs). Transform data 322 also includes data that maps characteristics of a block to the various inverse transforms, e.g., size and prediction mode information. In some examples, the data may map sizes of 4×4, 4×8, 8×4, 4×16, 16×4, 8×8, 8×16, or 16×8 and intra-prediction modes to inverse NSPTs, and other sizes and/or prediction modes to inverse separable transforms (and possibly inverse LFNSTs). Thus, inverse transform processing unit 308 may apply an inverse NSPT to a transform block (i.e., a block of transform coefficients), without the use of an inverse separable transform, when the transform block corresponds to an intra-predicted block having a size of one of 4×4, 4×8, 8×4, 4×16, 16×4, 8×8, 8×16, or 16×8; and inverse transform processing unit 308 may apply an inverse separable transform to other transform blocks.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a device for decoding video data, the device comprising: a memory configured to store video data; and a processing system comprising one or more processors implemented in circuitry, the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

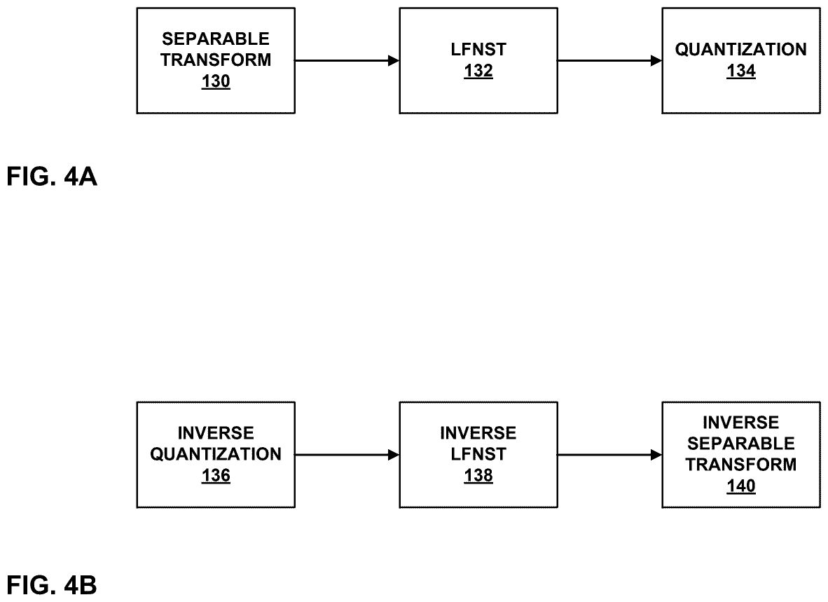

FIGS. 4A and 4B are conceptual diagrams illustrating the use of separable and low-frequency non-separable transforms (LFNSTs) when encoding and decoding video data. In particular, FIG. 4A depicts application of separable transform 130, followed by LFNST 132, then quantization 134. FIG. 4B depicts inverse quantization 136, followed by inverse LFNST 138, and then inverse separable transform 140. According to the techniques of this disclosure, video encoder 200 may apply separable transform 130 and LFNST 132 to blocks having sizes and/or prediction modes that are not mapped to NSPTs. Similarly, video decoder 300 may apply inverse LFNST 138 and inverse separable transform 140 to blocks having sizes and/or prediction modes that are not mapped to NSPTs.

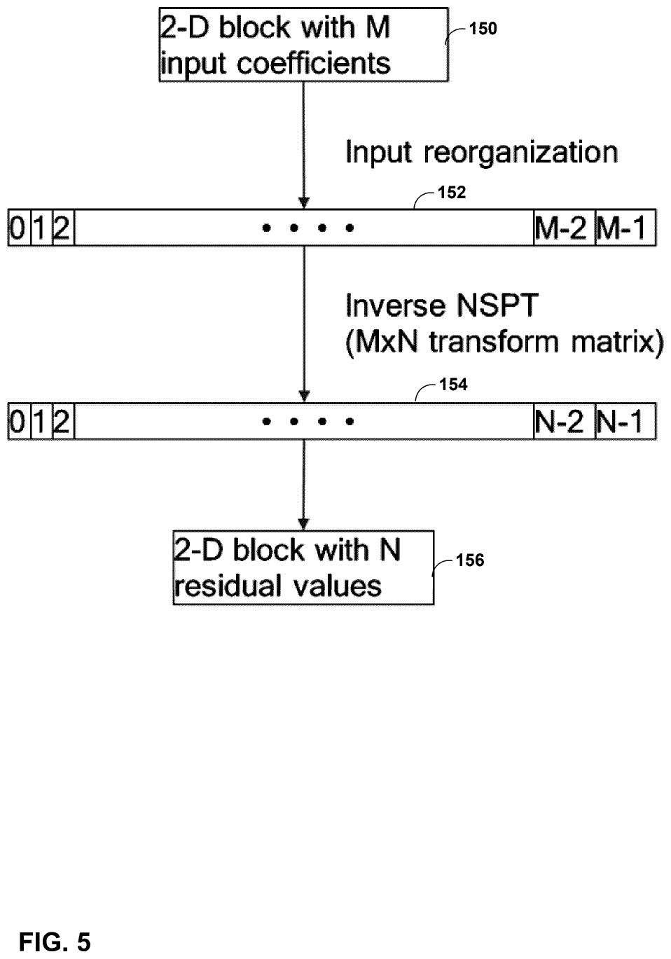

FIG. 5 is a conceptual diagram illustrating an inverse non-separable primary transform (NSPT) process. According to the techniques of this disclosure, after a list of two-dimensional (2-D) dequantized coefficients are obtained (based on a coefficient decoding step), video decoder 300 may apply an inverse non-separable primary transform (NSPT) to reconstruct residual values in a 2-D block/array, per FIG. 5. That is, inverse transform processing unit 212 of video encoder 200 of FIG. 2 and inverse transform processing unit 308 of video decoder 300 of FIG. 3 may apply an inverse NSPT to reconstruct a residual block of video data.

As shown in FIG. 5, initially a 2D block of M transform coefficients 150 may initially be reproduced, e.g., by inverse quantizing the transform coefficients. The values of 2D block of M transform coefficients 150 may be reorganized (152). An inverse NSPT (154) may then be applied to the reorganized block of transform coefficients. This results in a 2D block with N residual values 156, i.e., a reconstructed residual block.

A NSPT decoding process can be specified based on both: reorganization patterns/scans that may be used to define how NSPT input coefficients and output residual values are organized or grouped; and a transform matrix defining the non-separable transform used on all or a subset of dequantized coefficients.

In NSPT, a 2-D block/array of decoded coefficients need to be organized in order to align the entries of matrices and the input. This can be achieved by constructing a one-dimensional (1-D) list of coefficients M from the 2-D array of coefficients, then applying an inverse NSPT (of size M×N) on the 1-D list to reconstruct the residual block.

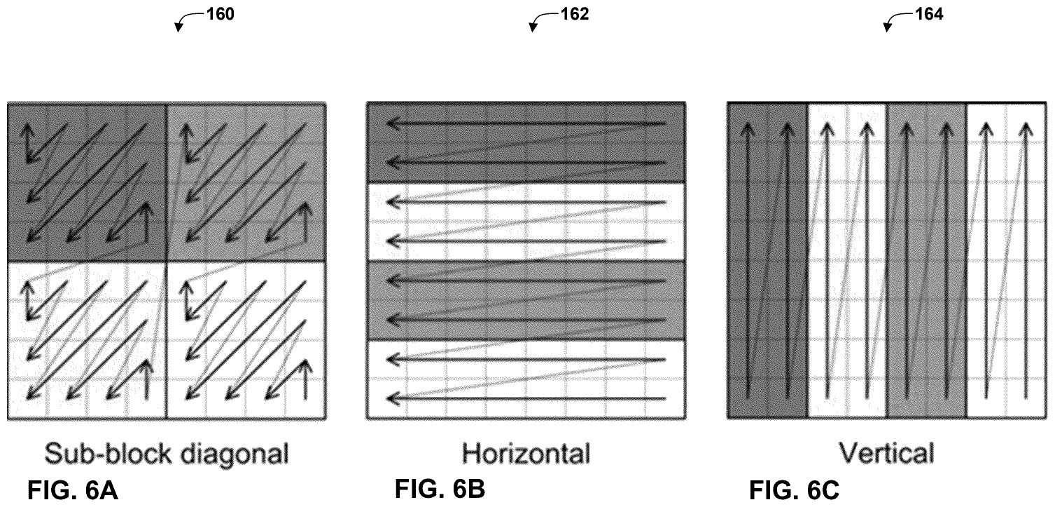

FIGS. 6A-6C are conceptual diagrams illustrating example scan patterns for reorganizing inverse quantized coefficients prior to application of an NSPT. In particular, FIG. 6A depicts a sub-block diagonal scan 160, FIG. 6B depicts a horizontal scan 162, and FIG. 6C depicts a vertical scan 164.

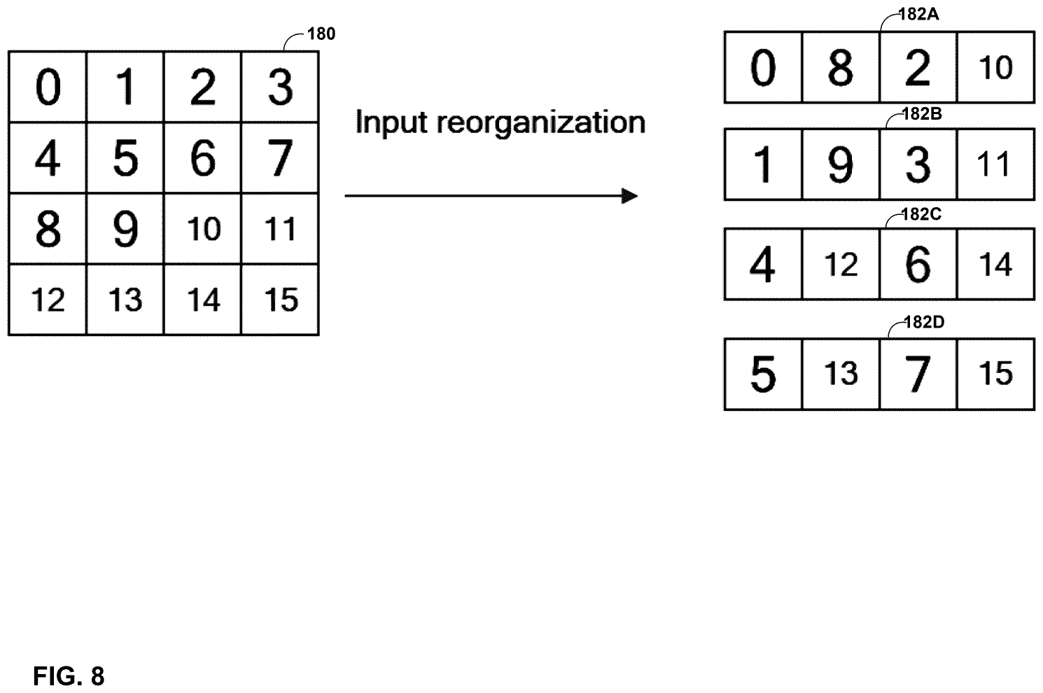

Input reorganization can be achieved using any of the various scans of FIGS. 6A-6C. The reorganization can also depend on block size and/or prediction mode (e.g., intra mode). If a codec normatively sets a subset of input coefficients to be zeroed-out, then an input coefficient list for NSPT may not include those zeroed-out coefficients. The reorganization step may accept only coefficients that can be non-zero (i.e., coefficients that are not normatively zeroed out). The reorganization may require de-interlacing the coefficients into multiple 1D arrays, as shown below with respect to FIG. 8.

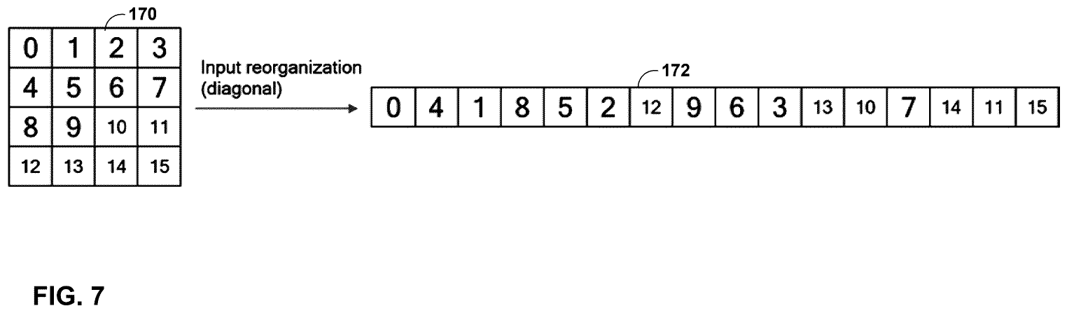

FIG. 7 is a conceptual diagram illustrating reordered one-dimensional array 172 constructed from two-dimensional matrix 170. In this example, original two-dimensional matrix 172 may be reordered into one-dimensional array 172 using sub-block diagonal scan 160 of FIG. 6A.

FIG. 8 is a conceptual diagram illustrating de-interlacing of a set of decoded coefficients 180 into four one-dimensional arrays 182A-182D.

The NSPT may be a matrix of size M×N, where M is an integer value that denotes the number of basis vectors and also denotes the number of rows, and Nis an integer value that denotes the number of reconstructed NSPT coefficients after applying the transform (also known as the number of support samples for the transform).

Video encoder 200 and video decoder 300 may reorganize a one-dimensional (1-D) list of N output NSPT coefficients based on an array (defining a pattern/scan), where each value in the array may correspond to a position/location in a 2-D block. The values in the array (used for reorganization) can denote indices of a 2-D block in any pre-defined order. As one example, the index values can correspond to a position in a 2-D block. Given an index value v, the corresponding position in the 2-D block can be calculated as: row index (r)=floor (v/w) and column index c=mod(v, w), where mod(x, y) represents a modulo operation that returns the remainder of dividing x by y, and where w represents a width of the NSPT sub-block.

Based on these formulas, the following reorganization array may correspond to the raster-order for 4×4 blocks:

const int raster_order 16 =
{ // 0 1 2 3 4 5 6 7 8 9 10 11 12 13 14 15
0, 1, 2, 3, 4, 5, 6, 7, 8, 9, 10, 11, 12, 13, 14, 15
};

Thus, the i^{th} element in the 1-D coefficient list is mapped to the row and column positions in the 2D block. For example, for i=0, 1, 2, . . . 15:

$$r [ i ] = floor ( raster\_order [ i ] / w )$$

$$c [ i ] = mod ( raster\_order [ i ] , w )$$

The NSPT matrices may be grouped into sets S₀, S₁, S₂, . . . . Each set may include one or several candidates (matrices) C₀, C₁, C₂, . . . dedicated to a certain block size W×H. The number of S and C can vary in various examples. In one example, every intra mode is associated with a certain set in S. Therefore, there may be 97 possible sets S: S₀, S₁, . . . . S₉₆, assuming 97 intra modes being available. The transform may thus be chosen based on a candidate index, for example, C=4.

As another example, intra modes (0, . . . 96) may be mapped to respective indexes (e.g., 0, . . . 35) according to a lookup table, such as:

const uint8_t g_nsptLut[97] =
{ // 0 1 2 3 4 5 6 7 8 9 10 11 12 13 14 15 16 17 18 19 20 21
22 23 24 25 26 27 28 29 30 31 32 33 34 35 36 37 38 39 40 41 42
43 44 45 46 47 48 49 50 51 52 53 54 55 56 57 58 59 60 61 62 63
64 65 66 67 68 69 70 71 72 73 74 75 76 77 78 79 80 81 82 83 84
85 86 87 88 89 90 91 92 93 94 95 96
+0, 1, 2, 3, 4, 5, 6, 7, 8, 9, 10, 11, 12, 13, 14, 15, 16, 17, 18, 19, 20, 21, 22, 23,
24, 25, 26, 27, 28, 29, 30, 31, 32, 33, 34, 33, 32, 31, 30, 29, 28, 27, 26, 25, 24,
23, 22, 21, 20, 19, 18, 17, 16, 15, 14, 13, 12, 11, 10, 9, 8, 7, 6, 5, 4, 3, 2, 2, 2, 2,
2, 2, 2, 2, 2, 2, 2, 2, 2, 2, 2, 2, 2, 2, 2, 2, 2, 2, 2, 2, 2, 2, 2, 2, 2, 2, 2
};

Thus, in this example, there are 35 possible sets S: S₀, S₁, . . . . S₃₄. This mapping can be derived through symmetry considerations or other means. In case of symmetry, the reorganization of the residual block may be processed in transposed order. The NSPT matrix may be chosen based on a candidate index, for example, C=3.

As yet another example, only certain intra modes may be associated with NSPT. For example, intra modes 0 (PLANAR), mode 1 (DC), mode 18 (horizontal), mode 50 (vertical), and mode 34 (diagonal). Therefore, there may be five sets S: S₀, S₁, S₂, S₃, S₄. Only one candidate can be chosen, such that a candidate index is not required, and therefore, C=1.

S and C can vary depending on the block size W×H. For certain block sizes, NSPT matrices may not be present and therefore S=0, C=0.

In some examples, NSPT matrices are present for block sizes 4×4, 4×8, 8×4, 8×8, i.e., NSPT4×4, NSPT4×8, NSPT8×4, NSPT8×8. Each NSPT class may include a set of 35 sets S, depending on the intra mode and C=3 candidates.

Additionally, in some examples, NSPT matrices are present for block sizes 16×16 or higher. The following examples address possibilities to process larger blocks with NSPT:
For block size 16×16, a dedicated NSPT16×16 class is used, including 35 sets S and 3 candidates C.
The block of size 16×16 may be separated into 4 sub-groups of size 4×4. Each 4×4 sub-group is processed by a dedicated NSPT4×4 class including 35 sets S and 3 candidates C. After forward-transform (performed by video encoder 200), the coefficients of each of the 4 sub-groups are interlaced according to their energy. Video decoder 300 may revert the interlacing (e.g., per FIG. 8), leading to 4 1D-arrays of dequantized coefficients, which are each inverse transformed using the dedicated NSPT4×4 class, set and candidate.
   Additionally, a block of 32×32 can be separated into 4 sub-groups of size 16×16 (processed by dedicated NSPT16×16 transforms) or 16 sub-groups of size 4×4 (processed by dedicated NSPT4×4 transforms).
A block of size W×H can be separated into L sub-groups of arbitrary sizes. For example, a 32×32 block can be separated into one 24×32 (processed by NSPT24×32) and one 8×32 sub-group (processed by NSPT8×32). The separation can depend on the intra mode and block size.
The coefficients of a 32×32 block may be processed using a dedicated NSPT16×16. After inverse transform and reordering, a 16×16 residual block is recovered. The residual block may be upsampled to size 32×32.

In some examples, NSPT & LFNST matrices are present for block sizes 4×4, 4×8, 8×4, 8×8. Each block size may correspond to one of three candidates (C₀, C₁, C₂) in a set depending on the intra mode (35 sets S) utilizing symmetry. The 3 candidates may be either NSPT or LFNST kernels, e.g., candidate 1 is NSPT, candidates 2 and 3 are LFNST, and so on.

For non-square blocks, the following special case may apply in order to exploit symmetry: If the residual block is transposed, the dimensions exchange (e.g., 4×8->8×4). Therefore, a transposed 4×8 block may use the transform matrices associated with the non-transposed 8×4 blocks, and vice versa.

For example, a 4×8 block containing dequantized coefficients may need to be processed using NSPT. First, the coefficients may be reordered to a 1D-array. Next, the intra mode of the block may be used to decide if the encoder-side residual was transposed prior to forward transform. Conceptually, vertical modes may be mapped to horizontal modes. A block may be transposed if the intra mode is in the range (34, . . . , 67). Two cases can happen: if the intra mode is smaller 34, the indicated set and candidate of NSPT4×8 may be used to inverse transform the reordered 1D-array. The residual values may then be reordered into a 2D residual block without transposing. On the other hand, if the intra mode is in the range of (34, . . . 67), the indicated set and candidate of NSPT8×4 may be used to inverse transform the reordered 1D-array. The residual values may be reordered into a 2D residual block and the block may be transposed.

The signs of coefficients derived through the application of NSPT can be predicted through sign prediction. In one example, the sign prediction follows the LFNST design, i.e., only the signs of up to 4 coefficients can be predicted, limited to a top-left 4×4 area. In another example, up to 4 coefficient signs can be predicted in an area adaptively increased to 32×32.

For hardware implementations, a worst-case number of multiplication (per-transform coefficient) may be an important complexity criterion. One simple method to reduce worst-case number of multiplications is to normatively zero-out some of the transform coefficients. However, the zeroing-out process may generally be undesirable unless it is required to meet a certain worst-case number of multiplications. For NSPT, the extent of zero-out may depend on the size of the block and current complexity limitations, which may change in the future. This matter defines the size M×N of the NSPT matrices.

In some examples, 4×4 residual blocks, the NSPT4×4 matrices are of size 16×16, and all 16 NSPT coefficients are retained.

In some examples, for 4×8 and 8×4 residual blocks, the NSPT4×8 and NSPT8×4 matrices are of size 32×20. 20 out of 32 NSPT coefficients are retained. The remaining 12 coefficients are set equal to zero.

In some examples, for 8×8 residual blocks, the NSPT8×8 matrices are 64×32. 32 out of 64 NSPT coefficients are retained. The remaining 32 are set to zero.

Video encoder 200 and video decoder 300 may be configured to apply NSPT to block sizes larger than 8×8, such as blocks of sizes 4×16, 16×4, 8×16, 16×8 and 16×16. These techniques may also be extended to even larger sizes, such as 32×N and N×32, but the transform coefficient storage may become an issue. In order to address the storage issue along with computational complexity, the following techniques can be employed.

In some examples, video encoder 200 and video decoder 300 may be configured to apply NSPT to blocks of sizes 4×16 and/or 16×4, and the storage requirements for transforms for these block sizes may be equivalent to the 8×8 case. A zero-out mechanism as discussed above can be employed where only 20, 24, or 32 resulting coefficients are stored, and the rest of the coefficients may be normatively set to zero. Video encoder 200 and video decoder 300 may determine the number of coefficients to keep based on a complexity and performance trade-off that is kept below a certain worst case computation complexity (e.g., multiplication and addition operations).

In some examples, video encoder 200 and video decoder 300 may be configured to apply NSPT to blocks of sizes 8×16, 16×8, or 16×16 blocks. The zero-out mechanism described above may be employed where only 32 or 40 coefficients are kept for 8×16 or 16×8 sized blocks, and 32, 40, or 44 resulting coefficients may be kept for 16×16 sized blocks. Video encoder 200 and video decoder 300 may set the rest of the coefficients to zero.

The storage requirements for larger transforms can be reduced by using a smaller number of transform sets. This could be achieved by reducing the number of mapped intra modes down from 35 as described above by clustering neighboring directional intra prediction modes further to reduce the number of mapped intra modes. The larger transform block sizes would have a smaller number of mapped intra modes. For example, 16×16 blocks may only have 4 mapped modes, whereas 8×16 or 16×8 blocks may have 11 mapped modes.

In some examples, for a particular block size, NSPT may be applied for certain intra modes and LFNST may be applied for other intra modes.

Alternatively, for a particular block size and intra prediction mode, certain signalled transform selection indices (e.g., a low frequency non-separable transform index syntax element, lfnst_idx) can correspond to whether NSPT or LFNST is to be used. In some examples, other transform indices may correspond to LFNST.

In some examples, three different non-separable kernels are used per mapped intra prediction mode. One of the non-separable kernels may correspond to NSPT and the other two non-separable kernels may correspond to LFNST kernels. In some examples, video encoder 200 and video decoder 300 may be configured to apply a combination of mixing LFNST and NSPT kernels based on intra prediction mode and a signalled index value.

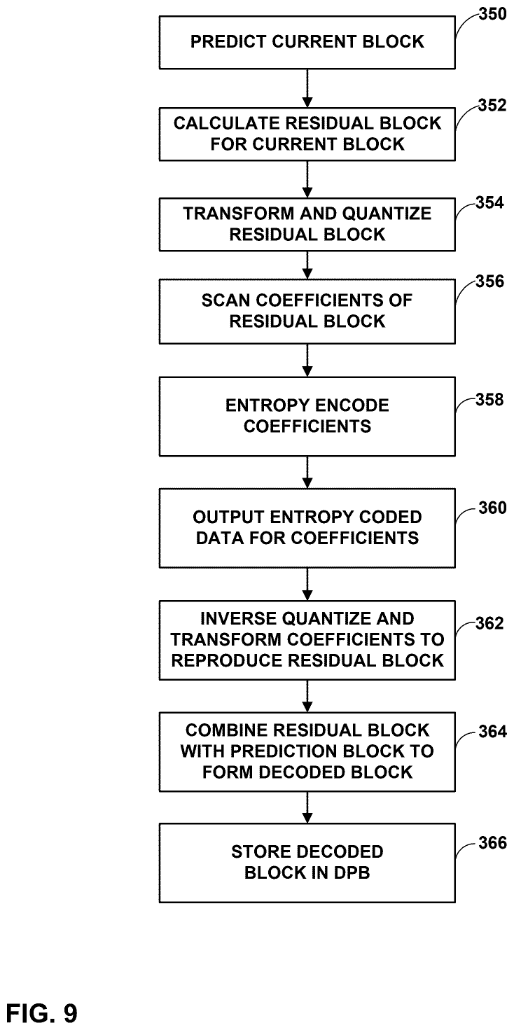

FIG. 9 is a flowchart illustrating an example method for encoding a current block in accordance with the techniques of this disclosure. The current block may comprise a current CU. Although described with respect to video encoder 200 (FIGS. 1 and 2), it should be understood that other devices may be configured to perform a method similar to that of FIG. 9.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). For example, video encoder 200 may transform the residual block using a non-separable primary transform according to any of the various techniques of this disclosure, alone or in any combination. Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may inverse transform the coefficients using an NSPT according to any of the various techniques of this disclosure. Video encoder 200 may combine the residual block with the prediction block to form a decoded block (364). Video encoder 200 may then store the decoded block in DPB 218 (366).

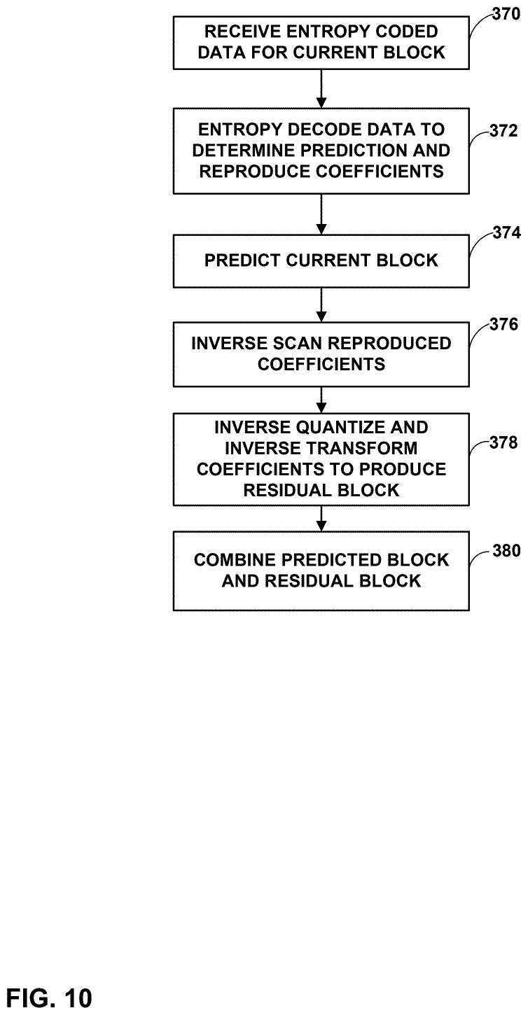

FIG. 10 is a flowchart illustrating an example method for decoding a current block of video data in accordance with the techniques of this disclosure. The current block may comprise a current CU. Although described with respect to video decoder 300 (FIGS. 1 and 3), it should be understood that other devices may be configured to perform a method similar to that of FIG. 10.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may inverse transform the coefficients using an NSPT according to any of the various techniques of this disclosure. Video decoder 300 may ultimately decode the current block by combining the prediction block and the residual block (380).

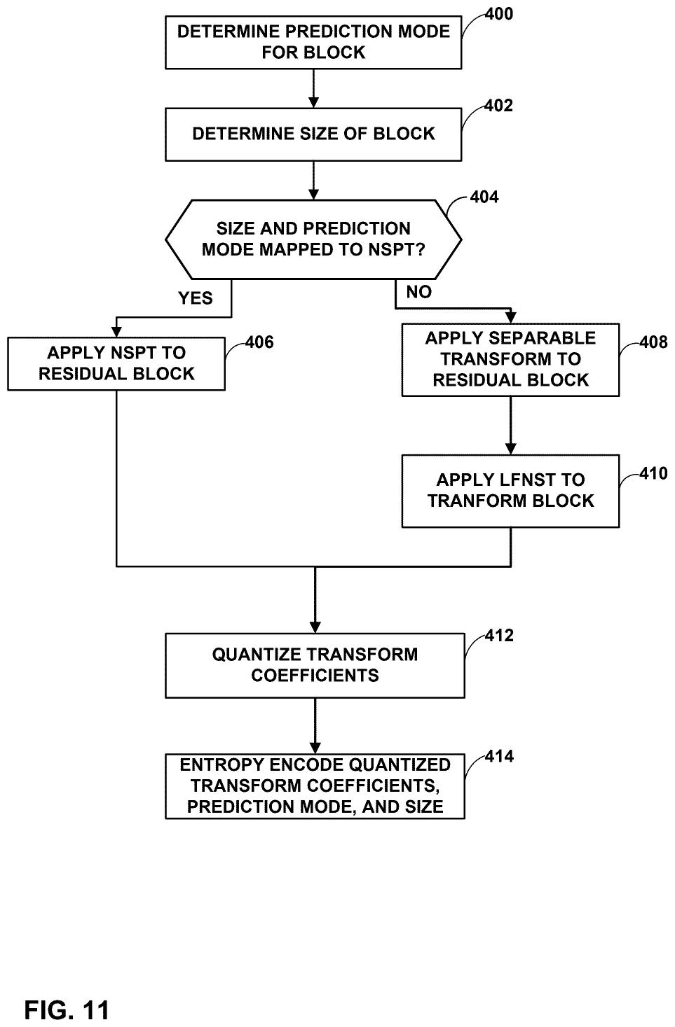

FIG. 11 is a flowchart illustrating an example method of encoding video data using a non-separable primary transform (NSPT) according to techniques of this disclosure. The method of FIG. 11 is explained with respect to video encoder 200 of FIGS. 1 and 2 for purposes of example. Other video encoding devices may be configured to perform this or a similar method. The method of FIG. 11 may generally correspond to step 354 of the method of FIG. 9.

Initially, video encoder 200 determines a prediction mode for a block of video data (400). Video encoder 200 also determines a size of the block (402). Video encoder 200 may then determine whether the size and the prediction mode are mapped to a non-separable primary transform (NSPT) (404). For example, sizes of 4×4, 4×8, 8×4, 4×16, 16×4, 8×8, 8×16, or 16×8 and intra-prediction modes may be mapped to NSPTs, whereas other combinations of sizes and prediction modes may be mapped to separable transforms (and, in some cases, low-frequency non-separable transforms).

Thus, if the size and prediction mode are mapped to an NSPT (“YES” branch of 404), video encoder 200 may apply the NSPT to the residual block to form a transform block (i.e., a block of transform coefficients). On the other hand, if the size and prediction mode are not mapped to an NSPT (“NO” branch of 404), video encoder 200 may apply a separable transform to the residual block (408) and, in some cases, apply an LFNST to at least a portion of the resulting transform block (410).

In either case, video encoder 200 may then quantize the resulting transform coefficients (412) and entropy encode the quantized transform coefficients, prediction mode, and size data (414).

In this manner, the method of FIG. 11 represents an example of a method of encoding video data including transforming a residual block of video data using a non-separable primary transform (NSPT), without using a separable transform, to construct a block transform coefficients; and encoding the block of transform coefficients.

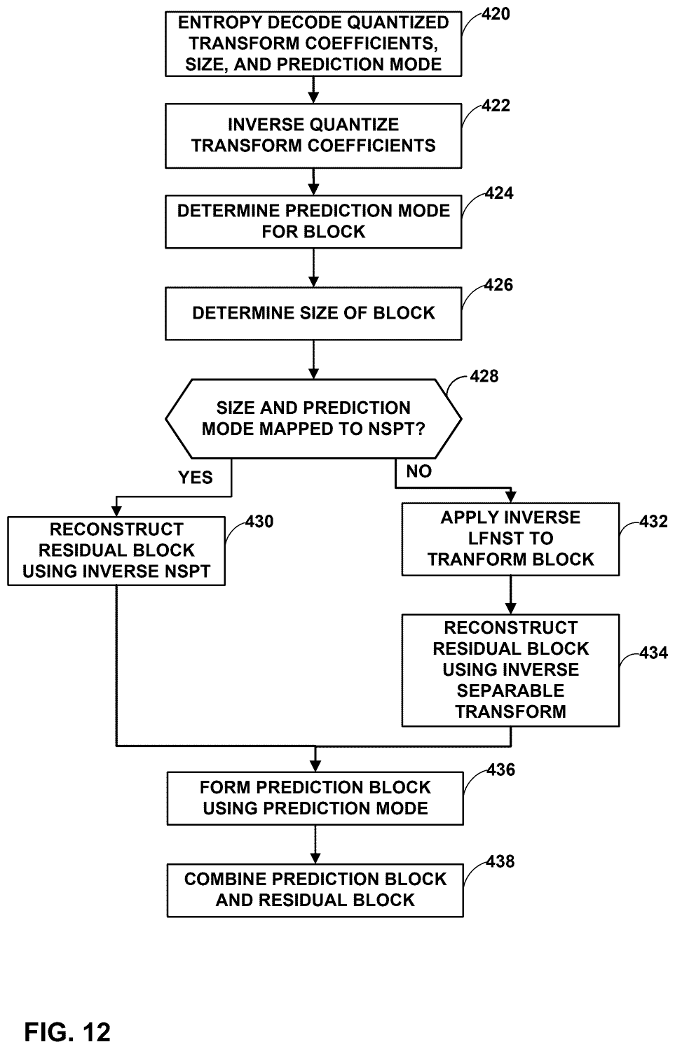

FIG. 12 is a flowchart illustrating an example method of decoding video data using a non-separable primary transform (NSPT) according to techniques of this disclosure. The method of FIG. 12 is explained with respect to video decoder 300 of FIGS. 1 and 3 for purposes of example. Other video decoding devices may be configured to perform this or a similar method. For example, the decoding loop portion of video encoder 200 may perform the method of FIG. 12 as well. The method of FIG. 12 may generally correspond to step 364 of the method of FIG. 9 or step 378 of the method of FIG. 10.

Initially, video decoder 300 entropy decodes quantized transform coefficients (420), size data, and a prediction mode for a current block of video data (420). Video decoder 300 may inverse quantize the quantized transform coefficients (422) to reconstruct a block of transform coefficients. Video decoder 300 may also determine the prediction mode for the block (424) and determine the size of the block (426) using the entropy decoded data.

Video decoder 300 may then determine whether the size and prediction mode are mapped to an NSPT (428). If the size and prediction mode are mapped to an NSPT (“YES” branch of 428), video decoder 300 may inverse transform the block of transform coefficients using the corresponding NSPT (430) to reconstruct a residual block for the block, i.e., without applying an inverse separable transform when reconstructing the residual block. On the other hand, if the size and prediction mode are not mapped to the NSPT (“NO” branch of 428), video decoder 300 may apply an inverse LFNST to the transform block (432) and reconstruct the residual block using an inverse separable transform (434).

In either case, video decoder 300 may form a prediction block using the indicated prediction mode (436) and combine the prediction block with the residual block to reconstruct the current block (438).

In this manner, the method of FIG. 11 represents an example of a method of decoding video data including inverse transforming a block of transform coefficients of a block of video data using an inverse non-separable primary transform (NSPT), without using an inverse separable transform, to reconstruct a residual block of the block of video data; and decoding the block of video data using the residual block.

Various examples of the techniques of this disclosure are summarized in the following clauses:

Clause 1: A method of decoding video data, the method comprising: inverse transforming a block of transform coefficients of a block of video data using an inverse non-separable primary transform (NSPT) to reconstruct a residual block of the block of video data; and decoding the block of video data using the residual block.

Clause 2: The method of clause 1, wherein inverse transforming the block of transform coefficients comprises: reorganizing the block of transform coefficients to form a reorganized block of transform coefficients; and inverse transforming the reorganized block of transform coefficients.

Clause 3: The method of any of clauses 1 and 2, wherein inverse transforming the block of transform coefficients comprises: constructing a one-dimensional list of coefficients from the block of transform coefficients; and applying the inverse NSPT to the one-dimensional list of coefficients to reconstruct the residual block.

Clause 4: The method of clause 3, wherein constructing the one-dimensional list of coefficients from the block of transform coefficients comprises applying a sub-block diagonal scan to the block of transform coefficients.

Clause 5: The method of clause 3, wherein constructing the one-dimensional list of coefficients from the block of transform coefficients comprises applying a horizontal scan to the block of transform coefficients.

Clause 6: The method of clause 3, wherein constructing the one-dimensional list of coefficients from the block of transform coefficients comprises applying a vertical scan to the block of transform coefficients.

Clause 7: The method of any of clauses 1-6, wherein the inverse NSPT is defined as a matrix of size M×N, where M is an integer value denoting a number of basis vectors and also a number of rows in the matrix and where N is an integer value denoting a number of support samples for the inverse NSPT.

Clause 8: The method of clause 7, wherein the matrix includes eight-bit precision values.

Clause 9: The method of any of clauses 1-8, further comprising selecting the inverse NSPT from a set of possible inverse NSPTs.

Clause 10: The method of clause 9, further comprising selecting the set of possible inverse NSPTs from a plurality of sets of possible inverse NSPTs.

Clause 11: The method of clause 10, wherein selecting the set of possible inverse NSPTs comprises selecting the set of possible inverse NSPTs according to an intra-prediction mode for the block of video data.

Clause 12: The method of any of clauses 9-11, wherein selecting at least one of the set of possible inverse NSPTs or the inverse NSPT comprises selecting the at least one of the set of possible inverse NSPTs or the inverse NSPT according to a size of the block of video data.

Clause 13: The method of any of clauses 1-12, further comprising performing sign prediction to predict one or more signs for one or more of the transform coefficients.

Clause 14: The method of any of clauses 1-13, wherein decoding the block of video data comprises: forming a prediction block for the block of video data; and combining the prediction block with the residual block to form a decoded block for the block of video data.

Clause 15: The method of any of clauses 1-14, wherein the block of transform coefficients is one of a 4×16 or 16×4 block, and wherein inverse transforming the block of transform coefficients comprises inverse transforming 20, 24, or 32 non-zero-valued transform coefficients and zero-valued transform coefficients for remaining transform coefficients.

Clause 16: The method of clause 15, wherein when there are 20 non-zero-valued transform coefficients, the remaining transform coefficients are 44 zero-valued transform coefficients, when there are 24 non-zero-valued transform coefficients, the remaining transform coefficients are 40 zero-valued transform coefficients, or when there are 32 non-zero-valued transform coefficients, the remaining transform coefficients are 32 zero-valued transform coefficients.

Clause 17: The method of any of clauses 1-14, wherein the block of transform coefficients is one of an 8×16 block or a 16×8 block, and wherein inverse transforming the block of transform coefficients comprises inverse transforming 32 or 40 non-zero-valued transform coefficients and zero-valued transform coefficients for remaining transform coefficients.

Clause 18: The method of clause 17, wherein when there are 32 non-zero-valued transform coefficients, the remaining transform coefficients are 96 zero-valued transform coefficients, or when there are 40 non-zero-valued transform coefficients, the remaining transform coefficients are 88 zero-valued transform coefficients.

Clause 19: The method of any of clauses 1-14, wherein the block of transform coefficients is one a 16×16 block, and wherein inverse transforming the block of transform coefficients comprises inverse transforming 32, 40, or 44 non-zero-valued transform coefficients and zero-valued transform coefficients for remaining transform coefficients.

Clause 20: The method of clause 19, wherein when there are 32 non-zero-valued transform coefficients, the remaining transform coefficients are 224 zero-valued transform coefficients, when there are 40 non-zero-valued transform coefficients, the remaining transform coefficients are 216 zero-valued transform coefficients, or when there are 44 non-zero-valued transform coefficients, the remaining transform coefficients are 212 zero-valued transform coefficients.

Clause 21: The method of clause 1, wherein inverse transforming the block of transform coefficients comprises: reorganizing the block of transform coefficients to form a reorganized block of transform coefficients; and inverse transforming the reorganized block of transform coefficients.

Clause 22: The method of clause 1, wherein inverse transforming the block of transform coefficients comprises: constructing a one-dimensional list of coefficients from the block of transform coefficients; and applying the inverse NSPT to the one-dimensional list of coefficients to reconstruct the residual block.

Clause 23: The method of clause 16, wherein constructing the one-dimensional list of coefficients from the block of transform coefficients comprises applying a sub-block diagonal scan to the block of transform coefficients.

Clause 24: The method of clause 16, wherein constructing the one-dimensional list of coefficients from the block of transform coefficients comprises applying a horizontal scan to the block of transform coefficients.

Clause 25: The method of clause 16, wherein constructing the one-dimensional list of coefficients from the block of transform coefficients comprises applying a vertical scan to the block of transform coefficients.

Clause 26: The method of clause 1, wherein the inverse NSPT is defined as a matrix of size M×N, where M is an integer value denoting a number of basis vectors and also a number of rows in the matrix and where N is an integer value denoting a number of support samples for the inverse NSPT.

Clause 27: The method of clause 20, wherein the matrix includes eight-bit precision values.

Clause 28: The method of clause 1, further comprising selecting the inverse NSPT from a set of possible inverse NSPTs.

Clause 29: The method of clause 22, further comprising selecting the set of possible inverse NSPTs from a plurality of sets of possible inverse NSPTs.

Clause 30: The method of clause 23, wherein selecting the set of possible inverse NSPTs comprises selecting the set of possible inverse NSPTs according to an intra-prediction mode for the block of video data.

Clause 31: The method of clause 22, wherein selecting at least one of the set of possible inverse NSPTs or the inverse NSPT comprises selecting the at least one of the set of possible inverse NSPTs or the inverse NSPT according to a size of the block of video data.

Clause 32: The method of clause 1, further comprising performing sign prediction to predict one or more signs for one or more of the transform coefficients.

Clause 33: The method of clause 1, wherein decoding the block of video data comprises: forming a prediction block for the block of video data; and combining the prediction block with the residual block to form a decoded block for the block of video data.

Clause 34: The method of clause 1, wherein the block of transform coefficients is one of a 4×16 or 16×4 block, and wherein inverse transforming the block of transform coefficients comprises inverse transforming 20, 24, or 32 non-zero-valued transform coefficients and zero-valued transform coefficients for remaining transform coefficients.

Clause 35: The method of clause 34, wherein when there are 20 non-zero-valued transform coefficients, the remaining transform coefficients are 44 zero-valued transform coefficients, when there are 24 non-zero-valued transform coefficients, the remaining transform coefficients are 40 zero-valued transform coefficients, or when there are 32 non-zero-valued transform coefficients, the remaining transform coefficients are 32 zero-valued transform coefficients.

Clause 36: The method of clause 1, wherein the block of transform coefficients is one of an 8×16 block or a 16×8 block, and wherein inverse transforming the block of transform coefficients comprises inverse transforming 32 or 40 non-zero-valued transform coefficients and zero-valued transform coefficients for remaining transform coefficients.

Clause 37: The method of clause 36, wherein when there are 32 non-zero-valued transform coefficients, the remaining transform coefficients are 96 zero-valued transform coefficients, or when there are 40 non-zero-valued transform coefficients, the remaining transform coefficients are 88 zero-valued transform coefficients.

Clause 38: The method of clause 1, wherein the block of transform coefficients is one a 16×16 block, and wherein inverse transforming the block of transform coefficients comprises inverse transforming 32, 40, or 44 non-zero-valued transform coefficients and zero-valued transform coefficients for remaining transform coefficients.

Clause 39: The method of clause 38, wherein when there are 32 non-zero-valued transform coefficients, the remaining transform coefficients are 224 zero-valued transform coefficients, when there are 40 non-zero-valued transform coefficients, the remaining transform coefficients are 216 zero-valued transform coefficients, or when there are 44 non-zero-valued transform coefficients, the remaining transform coefficients are 212 zero-valued transform coefficients.

Clause 40: The method of clause 1, further comprising encoding the block of video data prior to decoding the block of video data.

Clause 41: The method of any of clauses 1-39, further comprising encoding the block of video data prior to decoding the block of video data.

Clause 42: A device for decoding video data, the device comprising one or more means for performing the method of any of clauses 1-41.

Clause 43: The device of clause 42, wherein the one or more means comprise one or more processors implemented in circuitry.

Clause 44: The device of any of clauses 42 and 43, further comprising a display configured to display the decoded video data.

Clause 45: The device of any of clauses 42-44, wherein the device comprises one or more of a camera, a computer, a mobile device, a broadcast receiver device, or a set-top box.

Clause 46: The device of clause 42-45, further comprising a memory configured to store the video data.

Clause 47: A computer-readable storage medium having stored thereon instructions that, when executed, cause a processor of a device for decoding video data to perform the method of any of clauses 1-41.

Clause 48: A device for decoding video data, the device comprising: means for inverse transforming a block of transform coefficients of a block of video data using an inverse non-separable primary transform (NSPT) to reconstruct a residual block of the block of video data; and means for decoding the block of video data using the residual block.

Clause 49: A method of decoding video data, the method comprising: inverse transforming a block of transform coefficients of a block of video data using an inverse non-separable primary transform (NSPT), without using an inverse separable transform, to reconstruct a residual block of the block of video data; and decoding the block of video data using the residual block.

Clause 50: The method of clause 49, further comprising: forming a prediction block for the block of video data using an intra-prediction mode; and determining the inverse NSPT according to the intra-prediction mode.

Clause 51: The method of clause 49, further comprising: determining that the size of the block of transform coefficients is one of 4×4, 4×8, 8×4, 4×16, 16×4, 8×8, 8×16, or 16×8; and selecting the inverse NSPT such that the inverse NSPT has a size corresponding to the size of the block.

Clause 52: The method of clause 49, further comprising retrieving coefficients for the inverse NSPT from a memory storing coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT.

Clause 53: The method of clause 49, wherein the block of transform coefficients comprises a first block of transform coefficients having a first size, the block of video data comprises a first block of video data, and the residual block comprises a first residual block, the method further comprising: determining that a second block of transform coefficients of a second block of video data has a second size different than the first size; based on the second size being different than the first size, inverse transforming the second block of transform coefficients using the inverse separable transform and an inverse low-frequency non-separable transform (LFNST) transform to reconstruct a second residual block of the second block of video data; and decoding the second block of video data using the second residual block.

Clause 54: The method of clause 49, wherein inverse transforming the block of transform coefficients comprises: reorganizing the block of transform coefficients to form a reorganized block of transform coefficients; and inverse transforming the reorganized block of transform coefficients.

Clause 55: The method of clause 49, wherein inverse transforming the block of transform coefficients comprises: constructing a one-dimensional list of coefficients from the block of transform coefficients; and applying the inverse NSPT to the one-dimensional list of coefficients to reconstruct the residual block.

Clause 56: The method of clause 55, wherein constructing the one-dimensional list of coefficients from the block of transform coefficients comprises applying a sub-block diagonal scan to the block of transform coefficients.

Clause 57: The method of clause 55, wherein constructing the one-dimensional list of coefficients from the block of transform coefficients comprises applying a horizontal scan to the block of transform coefficients.

Clause 58: The method of clause 55, wherein constructing the one-dimensional list of coefficients from the block of transform coefficients comprises applying a vertical scan to the block of transform coefficients.

Clause 59: The method of clause 49, wherein the inverse NSPT is defined as a matrix of size M×N, where M is an integer value denoting a number of basis vectors and also a number of rows in the matrix and where N is an integer value denoting a number of support samples for the inverse NSPT.

Clause 60: The method of clause 59, wherein the matrix includes eight-bit precision values.

Clause 61: The method of clause 49, further comprising selecting the inverse NSPT from a set of possible inverse NSPTs.

Clause 62: The method of clause 61, further comprising selecting the set of possible inverse NSPTs from a plurality of sets of possible inverse NSPTs.

Clause 63: The method of clause 62, wherein selecting the set of possible inverse NSPTs comprises selecting the set of possible inverse NSPTs according to an intra-prediction mode for the block of video data.

Clause 64: The method of clause 61, wherein selecting at least one of the set of possible inverse NSPTs or the inverse NSPT comprises selecting the at least one of the set of possible inverse NSPTs or the inverse NSPT according to a size of the block of video data.

Clause 65: The method of clause 49, further comprising performing sign prediction to predict one or more signs for one or more of the transform coefficients.

Clause 66: The method of clause 49, wherein decoding the block of video data comprises: forming a prediction block for the block of video data; and combining the prediction block with the residual block to form a decoded block for the block of video data.

Clause 67: The method of clause 49, wherein the block of transform coefficients is one of a 4×16 or 16×4 block, and wherein inverse transforming the block of transform coefficients comprises inverse transforming 20, 24, or 32 non-zero-valued transform coefficients and zero-valued transform coefficients for remaining transform coefficients.

Clause 68: The method of clause 67, wherein when there are 20 non-zero-valued transform coefficients, the remaining transform coefficients are 44 zero-valued transform coefficients, when there are 24 non-zero-valued transform coefficients, the remaining transform coefficients are 40 zero-valued transform coefficients, or when there are 32 non-zero-valued transform coefficients, the remaining transform coefficients are 32 zero-valued transform coefficients.

Clause 69: The method of clause 49, wherein the block of transform coefficients is one of an 8×16 block or a 16×8 block, and wherein inverse transforming the block of transform coefficients comprises inverse transforming 32 or 40 non-zero-valued transform coefficients and zero-valued transform coefficients for remaining transform coefficients.

Clause 70: The method of clause 69, wherein when there are 32 non-zero-valued transform coefficients, the remaining transform coefficients are 96 zero-valued transform coefficients, or when there are 40 non-zero-valued transform coefficients, the remaining transform coefficients are 88 zero-valued transform coefficients.

Clause 71: The method of clause 49, wherein the block of transform coefficients is one a 16×16 block, and wherein inverse transforming the block of transform coefficients comprises inverse transforming 32, 40, or 44 non-zero-valued transform coefficients and zero-valued transform coefficients for remaining transform coefficients.

Clause 72: The method of clause 71, wherein when there are 32 non-zero-valued transform coefficients, the remaining transform coefficients are 224 zero-valued transform coefficients, when there are 40 non-zero-valued transform coefficients, the remaining transform coefficients are 216 zero-valued transform coefficients, or when there are 44 non-zero-valued transform coefficients, the remaining transform coefficients are 212 zero-valued transform coefficients.

Clause 73: The method of clause 49, further comprising encoding the block of video data prior to decoding the block of video data.

Clause 74: A device for decoding video data, the device comprising: a memory configured to store video data; and a processing system comprising one or more processors implemented in circuitry, the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

Clause 75: The device of clause 74, wherein the processing system is further configured to: form a prediction block for the block of the video data using an intra-prediction mode; and determine the inverse NSPT according to the intra-prediction mode.

Clause 76: The device of clause 74, wherein the processing system is further configured to: determine that the size of the block of transform coefficients is one of 4×4, 4×8, 8×4, 4×16, 16×4, 8×8, 8×16, or 16×8; and select the inverse NSPT such that the inverse NSPT has a size corresponding to the size of the block of the video data.

Clause 77: The device of clause 74, wherein the memory is further configured to store coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT, and wherein the processing system is configured to retrieve the coefficients for one of the plurality of inverse NSPTs from the memory.

Clause 78: The device of clause 74, wherein the block of transform coefficients comprises a first block of transform coefficients having a first size, the block of the video data comprises a first block of the video data, and the residual block comprises a first residual block, and wherein the processing system is further configured to: determining that a second block of transform coefficients of a second block of the video data has a second size different than the first size; based on the second size being different than the first size, inverse transforming the second block of transform coefficients using the inverse separable transform and an inverse low-frequency non-separable transform (LFNST) transform to reconstruct a second residual block of the second block of video data; and decoding the second block of video data using the second residual block.

Clause 79: The device of clause 74, further comprising a display configured to display the decoded video data.

Clause 80: The device of clause 74, wherein the device comprises one or more of a camera, a computer, a mobile device, a broadcast receiver device, or a set-top box.

Clause 81: A device for decoding video data, the device comprising: means for inverse transforming a block of transform coefficients of a block of video data using an inverse non-separable primary transform (NSPT), without using an inverse separable transform, to reconstruct a residual block of the block of video data; and means for decoding the block of video data using the residual block.

Clause 82: The device of clause 81, further comprising: means for forming a prediction block for the block of video data using an intra-prediction mode; and means for determining the inverse NSPT according to the intra-prediction mode.

Clause 83: The device of clause 81, further comprising: means for determining that the size of the block of transform coefficients is one of 4×4, 4×8, 8×4, 4×16, 16×4, 8×8, 8×16, or 16×8; and means for selecting the inverse NSPT such that the inverse NSPT has a size corresponding to the size of the block.

Clause 84: The device of clause 81, further comprising means for retrieving coefficients for the inverse NSPT from a memory storing coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT.

Clause 85: The device of clause 81, wherein the block of transform coefficients comprises a first block of transform coefficients having a first size, the block of video data comprises a first block of video data, and the residual block comprises a first residual block, further comprising: means for determining that a second block of transform coefficients of a second block of video data has a second size different than the first size; means for inverse transforming the second block of transform coefficients using the inverse separable transform and an inverse low-frequency non-separable transform (LFNST) transform to reconstruct a second residual block of the second block of video data based on the second size being different than the first size; and means for decoding the second block of video data using the second residual block.

Clause 86: The device of clause 81, wherein the means for inverse transforming the block of transform coefficients comprises: means for reorganizing the block of transform coefficients to form a reorganized block of transform coefficients; and means for inverse transforming the reorganized block of transform coefficients.

Clause 87: A method of decoding video data, the method comprising: inverse transforming a block of transform coefficients of a block of video data using an inverse non-separable primary transform (NSPT), without using an inverse separable transform, to reconstruct a residual block of the block of video data; and decoding the block of video data using the residual block.

Clause 88: The method of clause 87, further comprising: forming a prediction block for the block of video data using an intra-prediction mode; and determining the inverse NSPT according to the intra-prediction mode.

Clause 89: The method of any of clauses 87 and 88, further comprising: determining that the size of the block of transform coefficients is one of 4×4, 4×8, 8×4, 4×16, 16×4, 8×8, 8×16, or 16×8; and selecting the inverse NSPT such that the inverse NSPT has a size corresponding to the size of the block.

Clause 90: The method of any of clauses 87-89, further comprising retrieving coefficients for the inverse NSPT from a memory storing coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT.

Clause 91: The method of any of clauses 87-90, wherein the block of transform coefficients comprises a first block of transform coefficients having a first size, the block of video data comprises a first block of video data, and the residual block comprises a first residual block, the method further comprising: determining that a second block of transform coefficients of a second block of video data has a second size different than the first size; based on the second size being different than the first size, inverse transforming the second block of transform coefficients using the inverse separable transform and an inverse low-frequency non-separable transform (LFNST) transform to reconstruct a second residual block of the second block of video data; and decoding the second block of video data using the second residual block.

Clause 92: The method of any of clauses 87-91, wherein inverse transforming the block of transform coefficients comprises: reorganizing the block of transform coefficients to form a reorganized block of transform coefficients; and inverse transforming the reorganized block of transform coefficients.

Clause 93: The method of any of clauses 87-92, wherein inverse transforming the block of transform coefficients comprises: constructing a one-dimensional list of coefficients from the block of transform coefficients; and applying the inverse NSPT to the one-dimensional list of coefficients to reconstruct the residual block.

Clause 94: The method of clause 93, wherein constructing the one-dimensional list of coefficients from the block of transform coefficients comprises applying a sub-block diagonal scan to the block of transform coefficients.

Clause 95: The method of any of clauses 93 and 94, wherein constructing the one-dimensional list of coefficients from the block of transform coefficients comprises applying a horizontal scan to the block of transform coefficients.

Clause 96: The method of any of clauses 93-95, wherein constructing the one-dimensional list of coefficients from the block of transform coefficients comprises applying a vertical scan to the block of transform coefficients.

Clause 97: The method of any of clauses 87-96, wherein the inverse NSPT is defined as a matrix of size M×N, where M is an integer value denoting a number of basis vectors and also a number of rows in the matrix and where N is an integer value denoting a number of support samples for the inverse NSPT.

Clause 98: The method of clause 97, wherein the matrix includes eight-bit precision values.

Clause 99: The method of any of clauses 87-98, further comprising selecting the inverse NSPT from a set of possible inverse NSPTs.

Clause 100: The method of clause 99, further comprising selecting the set of possible inverse NSPTs from a plurality of sets of possible inverse NSPTs.

Clause 101: The method of clause 100, wherein selecting the set of possible inverse NSPTs comprises selecting the set of possible inverse NSPTs according to an intra-prediction mode for the block of video data.

Clause 102: The method of any of clauses 100 and 101, wherein selecting at least one of the set of possible inverse NSPTs or the inverse NSPT comprises selecting the at least one of the set of possible inverse NSPTs or the inverse NSPT according to a size of the block of video data.

Clause 103: The method of any of clauses 87-102, further comprising performing sign prediction to predict one or more signs for one or more of the transform coefficients.

Clause 104: The method of any of clauses 87-103, wherein decoding the block of video data comprises: forming a prediction block for the block of video data; and combining the prediction block with the residual block to form a decoded block for the block of video data.

Clause 105: The method of any of clauses 87-104, wherein the block of transform coefficients is one of a 4×16 or 16×4 block, and wherein inverse transforming the block of transform coefficients comprises inverse transforming 20, 24, or 32 non-zero-valued transform coefficients and zero-valued transform coefficients for remaining transform coefficients.

Clause 106: The method of clause 105, wherein when there are 20 non-zero-valued transform coefficients, the remaining transform coefficients are 44 zero-valued transform coefficients, when there are 24 non-zero-valued transform coefficients, the remaining transform coefficients are 40 zero-valued transform coefficients, or when there are 32 non-zero-valued transform coefficients, the remaining transform coefficients are 32 zero-valued transform coefficients.

Clause 107: The method of any of clauses 87-106, wherein the block of transform coefficients is one of an 8×16 block or a 16×8 block, and wherein inverse transforming the block of transform coefficients comprises inverse transforming 32 or 40 non-zero-valued transform coefficients and zero-valued transform coefficients for remaining transform coefficients.

Clause 108: The method of clause 107, wherein when there are 32 non-zero-valued transform coefficients, the remaining transform coefficients are 96 zero-valued transform coefficients, or when there are 40 non-zero-valued transform coefficients, the remaining transform coefficients are 88 zero-valued transform coefficients.

Clause 109: The method of any of clauses 87-108, wherein the block of transform coefficients is one a 16×16 block, and wherein inverse transforming the block of transform coefficients comprises inverse transforming 32, 40, or 44 non-zero-valued transform coefficients and zero-valued transform coefficients for remaining transform coefficients.

Clause 110: The method of clause 109, wherein when there are 32 non-zero-valued transform coefficients, the remaining transform coefficients are 224 zero-valued transform coefficients, when there are 40 non-zero-valued transform coefficients, the remaining transform coefficients are 216 zero-valued transform coefficients, or when there are 44 non-zero-valued transform coefficients, the remaining transform coefficients are 212 zero-valued transform coefficients.

Clause 111: The method of any of clauses 87-110, further comprising encoding the block of video data prior to decoding the block of video data.

Clause 112: A device for decoding video data, the device comprising: a memory configured to store video data; and a processing system comprising one or more processors implemented in circuitry, the processing system being configured to: inverse transform a block of transform coefficients of a block of the video data using an inverse non-separable primary transform (NSPT), without using an inverse separable transform, to reconstruct a residual block of the block of the video data; and decode the block using the residual block.

Clause 113: The device of clause 112, wherein the processing system is further configured to: form a prediction block for the block of the video data using an intra-prediction mode; and determine the inverse NSPT according to the intra-prediction mode.

Clause 114: The device of any of clauses 112 and 113, wherein the processing system is further configured to: determine that the size of the block of transform coefficients is one of 4×4, 4×8, 8×4, 4×16, 16×4, 8×8, 8×16, or 16×8; and select the inverse NSPT such that the inverse NSPT has a size corresponding to the size of the block of the video data.

Clause 115: The device of any of clauses 112-114, wherein the memory is further configured to store coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT, and wherein the processing system is configured to retrieve the coefficients for one of the plurality of inverse NSPTs from the memory.

Clause 116: The device of any of clauses 112-115, wherein the block of transform coefficients comprises a first block of transform coefficients having a first size, the block of the video data comprises a first block of the video data, and the residual block comprises a first residual block, and wherein the processing system is further configured to: determining that a second block of transform coefficients of a second block of the video data has a second size different than the first size; based on the second size being different than the first size, inverse transforming the second block of transform coefficients using the inverse separable transform and an inverse low-frequency non-separable transform (LFNST) transform to reconstruct a second residual block of the second block of video data; and decoding the second block of video data using the second residual block.

Clause 117: The device any of clauses 112-116, further comprising a display configured to display the decoded video data.

Clause 118: The device of any of clauses 112-117, wherein the device comprises one or more of a camera, a computer, a mobile device, a broadcast receiver device, or a set-top box.

Clause 119: A device for decoding video data, the device comprising: means for inverse transforming a block of transform coefficients of a block of video data using an inverse non-separable primary transform (NSPT), without using an inverse separable transform, to reconstruct a residual block of the block of video data; and means for decoding the block of video data using the residual block.

Clause 120: The device of clause 119, further comprising: means for forming a prediction block for the block of video data using an intra-prediction mode; and means for determining the inverse NSPT according to the intra-prediction mode.

Clause 121: The device of any of clauses 119 and 120, further comprising: means for determining that the size of the block of transform coefficients is one of 4×4, 4×8, 8×4, 4×16, 16×4, 8×8, 8×16, or 16×8; and means for selecting the inverse NSPT such that the inverse NSPT has a size corresponding to the size of the block.

Clause 122: The device of any of clauses 119-121, further comprising means for retrieving coefficients for the inverse NSPT from a memory storing coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT.

Clause 123: The device of any of clauses 119-122, wherein the block of transform coefficients comprises a first block of transform coefficients having a first size, the block of video data comprises a first block of video data, and the residual block comprises a first residual block, further comprising: means for determining that a second block of transform coefficients of a second block of video data has a second size different than the first size; means for inverse transforming the second block of transform coefficients using the inverse separable transform and an inverse low-frequency non-separable transform (LFNST) transform to reconstruct a second residual block of the second block of video data based on the second size being different than the first size; and means for decoding the second block of video data using the second residual block.

Clause 124: The device of any of clauses 119-123, wherein the means for inverse transforming the block of transform coefficients comprises: means for reorganizing the block of transform coefficients to form a reorganized block of transform coefficients; and means for inverse transforming the reorganized block of transform coefficients.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a size of a block of video data;
determining that transform coefficients of the block of video data are to be inverse transformed using an inverse non-separable primary transform (NSPT), the transform coefficients having a first integer number of transform coefficients;
selecting the inverse NSPT according to the size of the block of video data;
inverse transforming the transform coefficients using the inverse NSPT to reconstruct a residual block of the block of video data, the residual block having a second integer number of residual values, the second integer number being larger than the first integer number; and
decoding the block of video data using the residual block.

2. The method of claim 1, wherein the size of the block of video data is one of a 4×8 block or an 8×4 block, the first integer number is 20, and the second integer number is 32.

3. The method of claim 1, wherein the size of the block of video data is an 8×8 block, the first integer number is 32, and the second integer number is 64.

4. The method of claim 1, further comprising determining an intra-prediction mode for the block of video data, wherein selecting the inverse NSPT is further based on the intra-prediction mode.

5. The method of claim 4, wherein selecting the inverse NSPT comprises:
selecting a class of possible inverse NSPTs from a plurality of classes of possible inverse NSPTs based on the size of the block; and
selecting the inverse NSPT from the selected class of possible inverse NSPTs based on the intra-prediction mode.

6. The method of claim 1, wherein inverse transforming the transform coefficients comprises:
constructing a one-dimensional list including the transform coefficients; and
applying the inverse NSPT to the one-dimensional list to reconstruct the residual block.

7. The method of claim 1, wherein decoding the block of video data comprises:
forming a prediction block for the block of video data; and
combining the prediction block with the residual block.

8. The method of claim 1, further comprising retrieving coefficients for the inverse NSPT from a memory storing coefficients for a plurality of inverse NSPTs, the plurality of inverse NSPTs including a 4×4 inverse NSPT, a 4×8 inverse NSPT, an 8×4 inverse NSPT, a 4×16 inverse NSPT, a 16×4 inverse NSPT, an 8×8 inverse NSPT, an 8×16 inverse NSPT, and a 16×8 inverse NSPT.

9. The method of claim 1, wherein the transform coefficients comprise first transform coefficients, the inverse NSPT comprises a first inverse NSPT, the size of the block of video data comprises a first size, the block of video data comprises a first block of video data, and the residual block comprises a first residual block, the method further comprising:
determining that a second block of video data has a second size different than the first size;
based on the second size being different than the first size, inverse transforming second transform coefficients of the second block using a second inverse NSPT different than the first inverse NSPT to reconstruct a second residual block of the second block of video data; and
decoding the second block of video data using the second residual block.

10. The method of claim 1, wherein the inverse NSPT is defined as a matrix of size M×N, where M is an integer value denoting a number of basis vectors and also a number of rows in the matrix, and where N is an integer value denoting a number of support samples for the inverse NSPT.

11. The method of claim 1, further comprising encoding the block of video data prior to decoding the block of video data.

12. The method of claim 1,
wherein selecting the inverse NSPT comprises selecting the inverse NSPT such that the inverse NSPT has a size corresponding to the size of the block, and
wherein inverse transforming the transform coefficients comprises inverse transforming the transform coefficients without using an inverse separable transform and without using a non-separable secondary transform.

13. A device for decoding video data, the device comprising:
a memory configured to store video data; and
a processing system comprising one or more processors implemented in circuitry, the processing system being configured to:
determine a size of a block of video data;
determine that transform coefficients of the block of video data are to be inverse transformed using an inverse non-separable primary transform (NSPT), the transform coefficients having a first integer number of transform coefficients;
select the inverse NSPT according to the size of the block of video data;
inverse transform the transform coefficients using the inverse NSPT to reconstruct a residual block of the block of video data, the residual block having a second integer number of residual values, the second integer number being larger than the first integer number; and
decode the block of video data using the residual block.

14. The device of claim 13, wherein the size of the block of video data is one of a 4×8 block or an 8×4 block, the first integer number is 20, and the second integer number is 32.

15. The device of claim 13, wherein the size of the block of video data is an 8×8 block, the first integer number is 32, and the second integer number is 64.

16. The device of claim 13, wherein the processing system is further configured to determine an intra-prediction mode for the block of video data, wherein to select the inverse NSPT, the processing system is further configured to select the inverse NSPT based on the intra-prediction mode.

17. The device of claim 16, wherein to select the inverse NSPT, the processing system is configured to:
select a class of possible inverse NSPTs from a plurality of classes of possible inverse NSPTs based on the size of the block; and
select the inverse NSPT from the selected class of possible inverse NSPTs based on the intra-prediction mode.

18. The device of claim 13, wherein to inverse transform the transform coefficients, the processing system is configured to:
construct a one-dimensional list including the transform coefficients; and
apply the inverse NSPT to the one-dimensional list to reconstruct the residual block.

19. The device of claim 13, wherein to decode the block of video data, the processing system is configured to:
form a prediction block for the block of video data; and
combine the prediction block with the residual block.

20. The device of claim 13, wherein the transform coefficients comprise first transform coefficients, the inverse NSPT comprises a first inverse NSPT, the size of the block of video data comprises a first size, the block of video data comprises a first block of video data, and the residual block comprises a first residual block, and wherein the processing system is further configured to:
determine that a second block of video data has a second size different than the first size;
based on the second size being different than the first size, inverse transform second transform coefficients of the second block using a second inverse NSPT different than the first inverse NSPT to reconstruct a second residual block of the second block of video data; and
decode the second block of video data using the second residual block.
